(19) United States
(12) Patent Application Publication
(10) Pub. No.: US 2011/0173059 A1
(43) Pub. Date: Jul. 14, 2011

(54) SYSTEM, METHOD AND APPARATUS FOR INCENTIVIZING THE USE OF SERVICES AND PRODUCTS BASED ON REAL-TIME INVENTORY LOADING

(76) Inventor: TODD BENSON, AUSTIN, TX (US)

(21) Appl. No.: 13/004,724

(22) Filed: Jan. 11, 2011

Related U.S. Application Data
(60) Provisional application No. 61/293,908, filed on Jan. 11, 2010.

(51) Int. Cl. G06Q 30/00

(52) U.S. Cl. 705/14.24

(57) ABSTRACT

A system and method for providing incentives for products and services to consumers in real time. A retailer or service provider determines that they have unused capacity or unsold inventory and creates an incentive for consumers to optimize their use of resources. The retailer or service provider determines the level of the incentive, the time window during which it will be offered, and the quantity of consumers that can receive the incentive. The retailer or service provider updates a database with the incentive. A consumer uses an application from a portable electronic device or a web based application and chooses a set of filter parameters to locate an offer that will fill their needs. The database is queried based on the filter parameters and a set of incentives is generated which is sent to the consumer. The consumer chooses an incentive and is given a coupon or offer code to redeem for the incentive. A report of this choice is sent to the retailer or service provider who offered the incentive, creating a reservation for the consumer.

### CROSS-REFERENCE TO RELATED APPLICATIONS

This application claims priority to U.S. Provisional Application No. 61/293,908, filed Jan. 11, 2010, entitled SYSTEM, METHOD AND APPARATUS FOR INCENTIVIZING THE USE OF SERVICES AND PRODUCTS BASED ON REAL-TIME INVENTORY LOADING, which is incorporated herein by reference.

### TECHNICAL FIELD

This invention relates to retail customer incentives. In one aspect, it relates to a method for providing incentives to customers based on the real time inventory or loading of a business.

### BACKGROUND

In a retail or service business a retailer or service provider often encounters a situation where they have unsold inventory or unused capacity going to waste, or conversely when they have not enough inventory or capacity to serve demand. Retailers and service providers often use coupons or other incentives in order to entice customers obtain services during times when capacity is going to waste or to buy products when inventory is not being sold as quickly as desired. Unfortunately there is some delay between the time that a retailer or service provider receives information that they have unsold inventory or unused capacity and the time at which a customer can be offered an incentive, which results in a suboptimal use of capacity or sale of inventory. Thus, the need for a system that can react in real time to quickly offer customers incentives has emerged.

### SUMMARY

The primary intent of this system is to use incentives to attract customers through portable handheld electronics or web based tools to utilize services or consume products based on real time loading or inventory. The incentive levels are controlled by the retailer or service agent and can be limited in both number of instances and time windows for use. The goal is to optimize resource utilization for the retailer by creating demand for their product during times when they would otherwise be underutilized. Underutilization can be caused by several things out of the retailers control such as weather, traffic or season. By adjusting the incentive the ultimate goal is to create normalized capacity usage to balance with human and product resources.

In one embodiment of the system a retailer or service provider determines a level of incentive, a time window and a quantity they are willing to offer based on their business conditions. These business conditions could be, for example, empty tables, excess inventory or a grand opening promotion. The incentives can also be directly related to the number of customers involved. For example, a restaurant may create a different offer for parties of two than parties of six based on which tables are currently empty.

Once determined, placement of the incentive on a continuously updating database can be accomplished by website, network connected POS type terminals or through a completely automated system.

A customer or user can use filters to narrow the focus of the product or service they are looking for. These filters can be, for example, physical distance, type of food, price range of product, value of incentive/discount or time window within which the incentive can be used. When using mobile electronics proximity determination can be automatic but proximity determination can also be accomplished by way of zip code or address reference in a web based system.

Once the filters are in place a continuously updated database of products and services will be searched for the best matches and offers will be presented to the user. The user can then review the offers, receiving additional information such as customer ratings and exact location of the service provider.

Once an offer is selected a reservation can be created and communicated to the service provider. The user is given a coupon or offer code that is generally in the form of a key word or electronic bar code to give to the retailer or service provider. A database limit on the number of reservations or coupons as well as a time window for validity of the offer is set by the retailer or service provider to avoid demand exceeding supply. This limit might actually be set slightly above the supply based on usage conversion rates that can be predicted once historical data is available.

When a coupon is used, the retailer or service provider records the event and provides feedback to the application developer for purposes such as conversion rate tracking and fee determination.

POS (Point Of Sale) terminals at the retailer location can be portable electronic devices such as an iPod touch or a smart phone running a retailer application. This application can also be run at any internet access point through a web based application. As an added benefit for retailers that do not already have a reservation system, the web based application or portable electronic devices can also serve as a reservation tracking device. Reservations that result from incentive placement can be merged with walk-ins or phone reservations through this system. For more advanced retailers with a reservation system in place, partnerships with reservation system providers such as Open Table are planned to allow reservations that are received via this system to merge directly into those systems already in place.

In an example of a consumer experience, Bob and Sue make a last minute decision to go to dinner on a Tuesday night and decide to have Mexican food. Through a web based application they filter for Mexican, within 5 miles of their address and incentive value of >$10. In response they get several options to choose from including an offer from Jose's Cantina for buy one get one free Entrees, which they select. The system asks them if they would like a booth or a table and they choose booth. Upon selection by Bob and Sue the restaurant gets notification, a booth is waiting for Bob and Sue when they arrive and the section server is aware of the offer they have selected.

In another example of a consumer experience, Julie wants to see a movie and there are four movie theaters in her area. She does a search for incentives on her iPhone and finds that one of the four theaters in the area is offering a free popcorn incentive on top of the normal matinee pricing for the 4PM showing of a movie she wants to see. When buying the ticket she gives the attendant the code she has received on her phone and receives the popcorn.

In a final example of a consumer experience, Christy wants to get her dog groomed before her family comes into town but does not know where to go and is on a budget. She does a search for her incentives in the area and finds that “Mark's Grooming” is offering a free king kong chew toy and $10 off. She makes the reservation and afterwards becomes a regular customer of Mark's.

In an example of a retailer or service provider experience, Dan owns a car wash and gets more business than his capacity when the weather is clear, however, when it is cloudy his business drops sharply as consumers are afraid of getting rained on right after washing. When the chance of rain is higher than 30% for his zip code according to an online weather service and he has less than 50% loading on his car wash he enables an incentive using a simple networked POS terminal for half price car washes. New customers needing a car wash see his incentive and his customer base expands. He also has many of his regulars shift their washes to his dead time and his overall loading is much more normalized.

In another example of a retailer or service provider experience, John is the manager of a local Italian restaurant. It is a Wednesday at 4PM and not only are 75% of his tables empty, a rehearsal dinner canceled for which he had ordered 50 T-bone steaks. He expects business to pick up at around 8PM but until then it might be dead. John logs into his web portal and creates 50 T-bone incentive coupons offering a free appetizer, drink and dessert with every $26.95 T-bone purchased between 4PM and 7:30PM today. 50 people register and 45 people arrive and purchase the steak within the time window. At John's decision the data base application sends out notifications to the 5 registered customers that did not come with the message, “Sorry you could not make it. Use this electronic coupon for one free appetizer the next time you join us.”

In a final example of a retailer or service provider experience, Susie operates a massage service. Reservations are hard to predict but generally speaking everyone wants massages on the week nights or on the weekends and she has random appointments scheduled during the work week, making it difficult to earn money or accomplish other tasks in the time between appointments. She cannot afford to turn down the business during the week and on the weekends she is forced to turn down business because of limited capacity. She utilizes the incentive program to try to fill the gaps during the week. She informs her regulars of this and those that have flexible schedules normally check for discounted openings during the week. She also receives new local customers and out of town travelers that use their mobile electronic devices to search for services when traveling. The net result is more business and more evenly distributed appointments. Susie is able to take Monday and Tuesday off and has more income as well.

It is possible to charge fees at many stages in the system, including: for enablement of the application to a user, for actual usage of the application by the user, for placement of incentives by the retailer or service provider, for use of a coupon at a retailer or service provider, or monthly for the placement of a limited or unlimited quantity of incentives by a retailer or service provider.

Fees do not have to be constant and can be scaled for prime time coupon or offer usage which is likely to be inversely proportional to typical service or product usage.

It is suspected at this time that the most successful business model is to offer free access to all services and applications for consumers with fees only being charged to the retailer or service provider in direct proportion to actual usage of coupons or offers.

It will be appreciated by those skilled in the art having the benefit of this disclosure that this system, method and apparatus for incentivizing the use of services and products based on real-time inventory loading provides optimization of the use of service capacity or sale of product inventory. It should be understood that the detailed description herein is to be regarded in an illustrative rather than a restrictive manner, and is not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for incentivizing the use of services and products based on real-time inventory loading, the method comprising:
determining a level of an incentive;
determining a time window of the incentive;
determining a quantity of the incentive to offer based upon at least one business condition;
updating a database with the incentive;
receiving at least one filtering parameter from a user;
querying the database using the at least one filtering parameter to generate filtered incentives;
providing a report of the filtered incentives to the user;
receiving a selection of a filtered incentive from the user;
sending an indication of the selected incentive to a service provider associated with the selected incentive; and
sending a coupon associated with the selected incentive to the user.
